(19) United States
(12) Patent Application Publication
(10) Pub. No.: US 2011/0116164 A1
(43) Pub. Date: May 19, 2011

(54) MICROSCOPE AND MICROSCOPE LENS BARREL

(75) Inventor: Shinichi YOKOUCHI, Nagano (JP)

(73) Assignee: OLYMPUS CORPORATION, Tokyo (JP)

(21) Appl. No.: 12/944,056

(22) Filed: Nov. 11, 2010

(30) Foreign Application Priority Data
Nov. 16, 2009 (JP) 2009-260739

(51) Int. Cl. G02B 21/06

(52) U.S. Cl. 359/385

(57) ABSTRACT

A microscope includes a fixed section, a moving section that is movable with respect to the fixed section, and a bellows type expandable light shielding section provided between the fixed section and the moving section, wherein bending sections of the light shielding member are thicker than wall sections of the light shielding member.

Benefit is claimed, under 35 U.S.C. §119, to the filing date of prior Japanese Patent Application No. 2009-260739 filed on Nov. 16, 2009. This application is expressly incorporated herein by reference. The scope of the present invention is not limited to any requirements of the specific embodiments described in the application.

### BACKGROUND OF THE INVENTION

1. Field of the Invention

The present invention relates to a microscope and a microscope lens barrel, and in detail relates to a microscope and a microscope lens barrel having a bellows type light shielding member.

2. Description of the Related Art

Microscopes using a bellows type light shielding member are known. For example, Japanese Patent laid-open No. 2005-345718 (laid-open Dec. 15, 2005) discloses a fluorescence microscope having a bellows type light shielding member provided between a stage of the fluorescence microscope, as a fixed section, and an objective lens, as a moving section, for shielding light between the fixed section and the moving section. This light shielding member is for blocking external light to a specimen, which is a subject of observation, and is of a bellows type in order to reliably perform light shielding even if there are changes in distance between the specimen and the objective lens.

Also, Japanese patent laid-open No. 2006-308002 (laid-open Nov. 9, 2006) discloses a constant velocity joint boot mounted on a vehicle axle, and a resin boot mounted on a shift lever, this resin boot adopting a bellows design in which valley portions of a bellows section are the same thickness or thicker than peak portions that that are adjacent to the valley portions.

### SUMMARY OF THE INVENTION

The present invention has been conceived in view of the above described situation, and provides a microscope and a microscope lens barrel that have a bellows type light shielding member in which adjacent walls of the light shielding member come into contact when the light shielding member is contracted, and that does not twist with a change in position of its bending sections.

A microscope according to one aspect of the present invention comprises a fixed section, a moving section that is movable with respect to the fixed section, and a bellows type expandable light shielding section provided between the fixed section and the moving section, wherein bending sections of the light shielding member are thinner than wall sections of the light shielding member.

A microscope lens barrel according to another aspect of the present invention is provided with an expandable mechanism, and includes a bellows type light shielding member that is extended or retracted by the expandable mechanism, with bending portions of the light shielding member being thinner than wall sections, an outer part of the upper surface being formed in a substantially square or substantially rectangular shape, containing a plate formed generally fitting to the upper surface, and upper and lower surfaces being thicker than the wall sections.

### BRIEF DESCRIPTION OF THE DRAWINGS

FIG. 1A and FIG. 1B are drawings showing the external appearance of a microscope of one embodiment of the present invention, FIG. 1A being a left side elevation of the microscope, and FIG. 1B being a front elevation of the microscope.

FIG. 2A and FIG. 2B are drawings showing the external appearance of the microscope of one embodiment of the present invention, when a lens barrel and a binocular section are at their minimum size, FIG. 2A being a left side elevation and FIG. 2B being a front elevation.

FIG. 3A and FIG. 35 are drawings showing the external appearance of the microscope of one embodiment of the present invention, when the lens barrel and the binocular section are at their maximum size, FIG. 3A being a left side elevation and FIG. 3B being a front elevation.

FIG. 4 is a cross sectional drawing of the microscope of one embodiment of the present invention, taken along line IV-IV in FIG. 2B, and shows a state in which the lens barrel and the binocular section are at their minimum size.

FIG. 5 is a cross sectional drawing of the microscope of one embodiment of the present invention, along the same direction as FIG. 4, and shows a state in which the lens barrel and the binocular section have been telescopically expanded.

FIG. 6 is a partial cross sectional drawing of the microscope of one embodiment of the present invention, along the same direction as FIG. 4, and shows a state in which the lens barrel and the binocular section have been expanded by lifting.

FIG. 7 is an exterior view of a light shielding member for the microscope of one embodiment of the present invention.

FIG. 8 is a partially cut away perspective view of the light shielding member for the microscope of one embodiment of the present invention.

FIG. 9 is a perspective view showing an attachment state of the light shielding member for the microscope of one embodiment of the present invention.

FIG. 10 is a partial cross sectional drawing of the light shielding member for the microscope of one embodiment of the present invention, showing an enlarged view of area X in FIG. 6.

FIG. 11 is a partial cross sectional drawing of the light shielding member for the microscope of one embodiment of the present invention, when the light shielding member is folded down.

FIG. 12A and FIG. 12B are external side views of the light shielding member for the microscope of one embodiment of the present invention, FIG. 12A showing when the light shielding member is extended, and FIG. 12B showing when the light shielding member is folded down.

FIG. 13 is a cross sectional drawing of a modified example 1 of the light shielding member for the microscope of one embodiment of the present invention.

FIG. 14 is a cross sectional drawing of a modified example 2 of the light shielding member for the microscope of one embodiment of the present invention.

FIG. 15 is a partial cross sectional drawing of the modified example 2 of the light shielding member for the microscope of one embodiment of the present invention, when the light shielding member is folded down.

FIG. 16 is a partial cross sectional drawing of a light shielding member for a microscope of the related art, when the light shielding member is folded down.

### DETAILED DESCRIPTION OF THE PREFERRED EMBODIMENTS

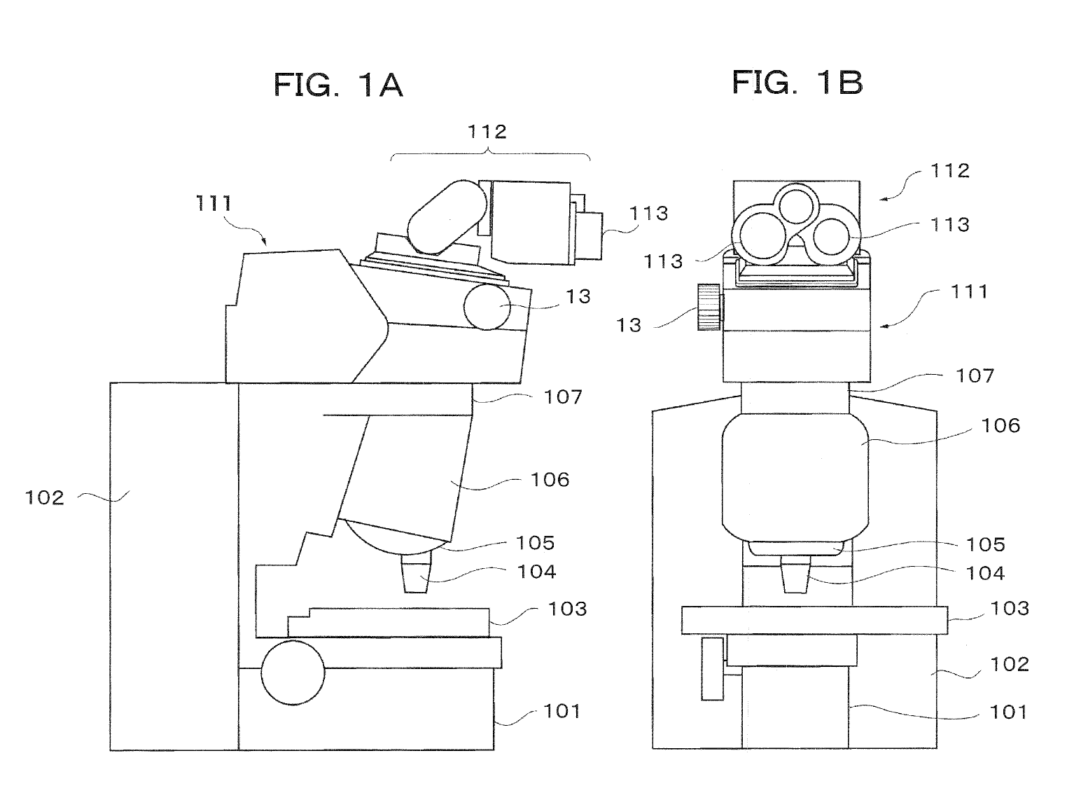

A preferred embodiment will be described in the following using a microscope adopting the present invention, in accordance with the drawings. FIG. 1A and FIG. 1B are drawings showing the external appearance of a microscope of one embodiment of the present invention, FIG. 1A being a left side elevation, and FIG. 1B being a front elevation. A base 101 has an illumination optical system arranged therein, and illuminates an observation specimen. A supporting column 102 is orthogonal to the base 101, and a support arm 107 is integrally formed with this supporting column 102, substantially parallel to the base 101. A basic structure having a generally open-ended square shape is formed by the base 101, the supporting column 102 and the support arm 107. A stage 103 is provided on the base 101, and an observation specimen can be mounted on this stage 103.

A revolver holding member 106 is provided on the support arm 107. A revolver 105 that rotates is arranged in a bottom part of this revolver holding member 106, and an objective lens 104 can be fitted into this revolver 105. An afocal optical system is arranged inside the revolver holding member 106, with the optical axis of this afocal optical system being coincident with the optical axis of the objective lens 104

A lens barrel 111 having an afocal optical system inside is provided at an upper part of the support arm 107. An output stage of the optical system inside the revolver holding member 106 and an input stage of the optical system inside the lens barrel 111 have coincident optical axes. The lens barrel 111 is provided with a lifting handle 13, and it is possible to carry out a lifting operation, specifically, to adjust the height of a binocular section 112 with respect to the lens barrel 111, by operating this lifting handle 13. Also, the lens barrel 111 can be extended in the telescoping direction (horizontal direction) as will be described later

The binocular section 112, having an optical system for dividing an optical image formed by the optical system inside the lens barrel 111 into two optical images, is provided in an upper part of the lens barrel 111. A pair of left and right ocular lenses 113 are arranged at an end section of this binocular section 112. The angle of this binocular section 112 in its holding section can also be varied.

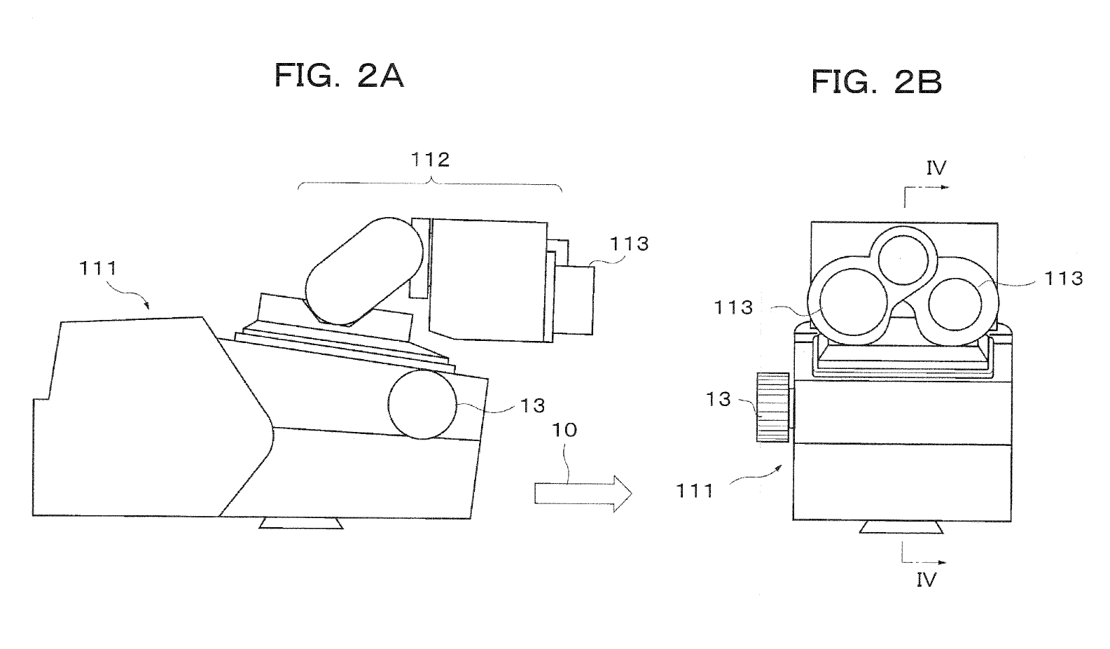

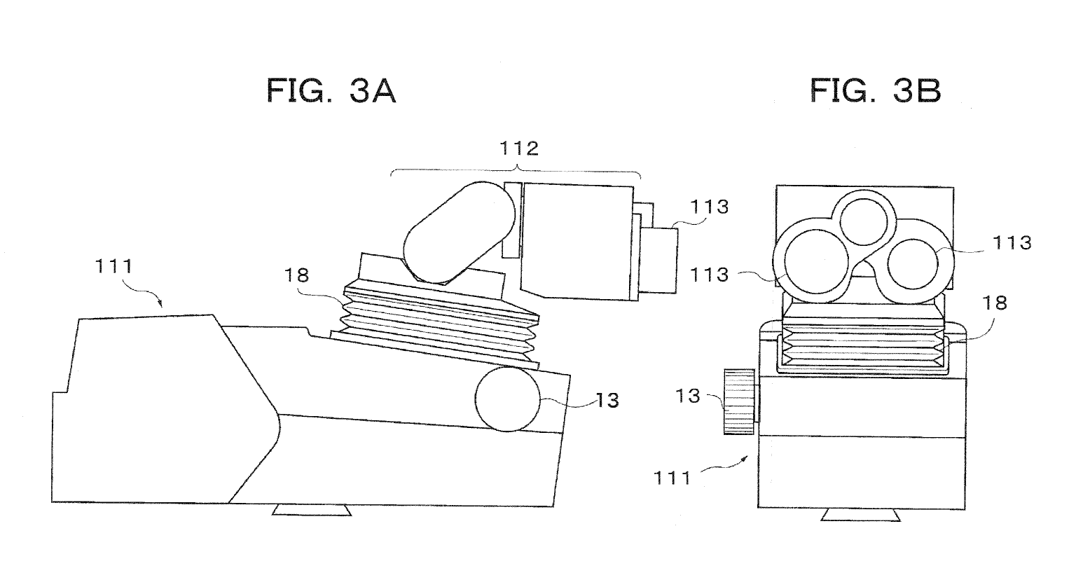

Next, the structure of the lens barrel 111 and the binocular section 112 will be described using FIG. 2A to FIG. 6. FIG. 2A, FIG. 2B and FIG. 3A and FIG. 3B are drawings showing the external appearance of the lens barrel 111 and the binocular section 112, with FIG. 2A and FIG. 2B showing a state where the apparatus is compressed to its minimum size in the horizontal direction by a telescopic operation, and to its minimum size in the vertical direction by a lifting operation, and with FIG. 3A and FIG. 3B showing a state where the apparatus is extended to its maximum size in the horizontal direction by a telescopic operation, and extended to its maximum size in the vertical direction by a lifting operation.

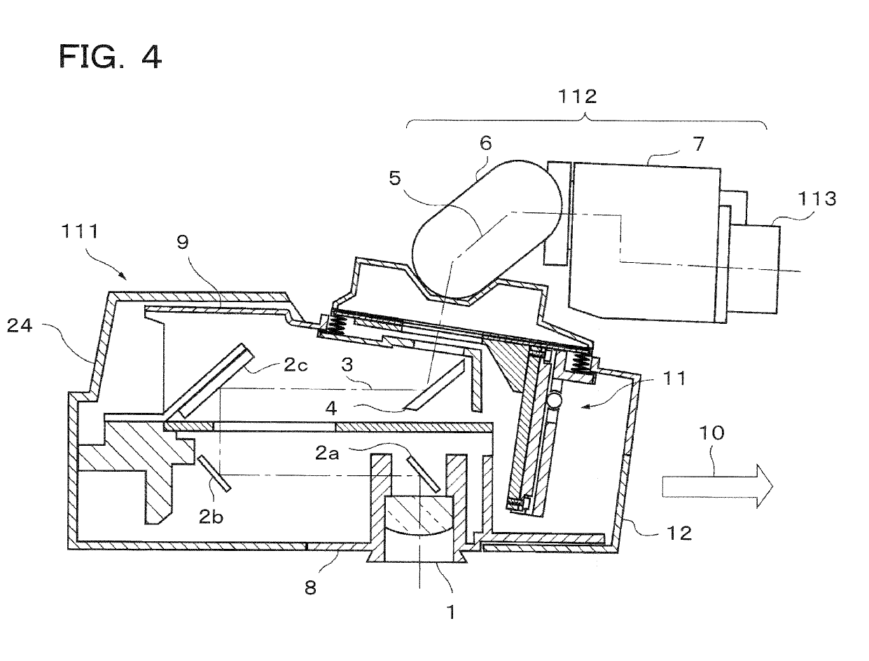

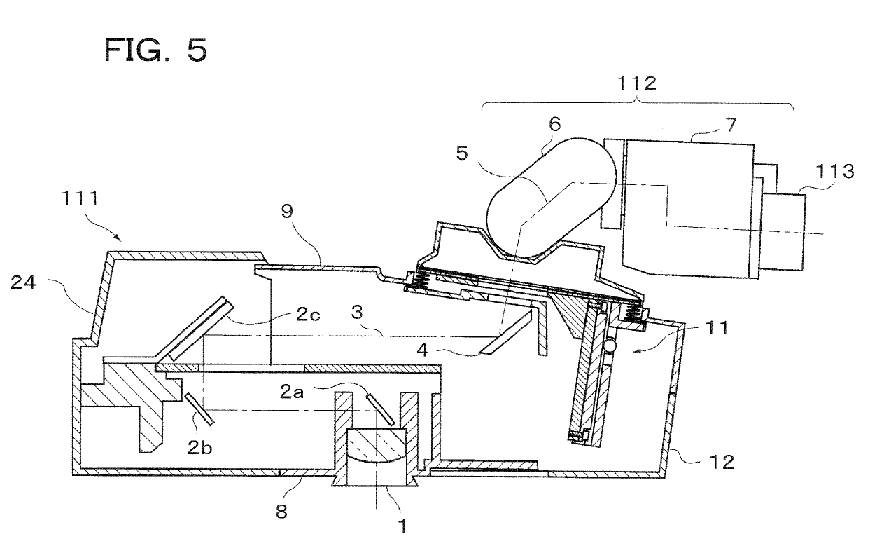

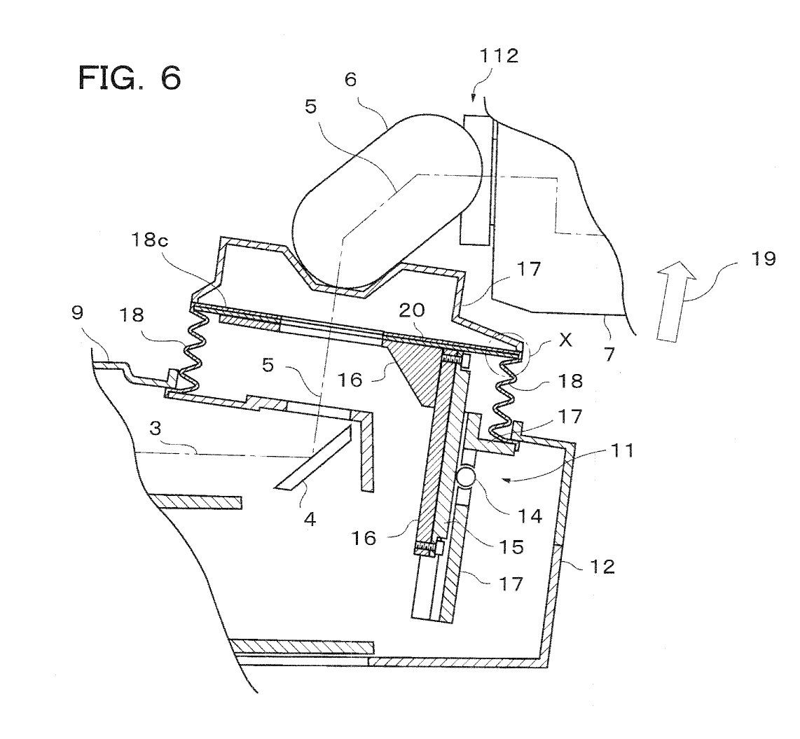

FIG. 4 is a cross section along the IV-IV direction in FIG. 2B, and shows a state where the apparatus is at its minimum size as a result of both the telescopic operation and the lifting operation. FIG. 5 is cross sectional drawing along the same direction as FIG. 4 and shows a state in which the apparatus has been telescopically extended from its minimum size in FIG. 4. FIG. 6 is a partial cross section along the same direction as FIG. 4, and shows a state in which the apparatus has been extended by lifting from its minimum size or from the telescopically extended state.

The lens barrel 111 comprises a telescopic fixed member 8 and a telescopic moving member 9. The telescopic fixed member 8 is fixed to the support arm 107, and the telescopic moving member 9 is slidably engaged with the telescopic fixed member 8 using a dovetail groove and so on, and is capable of moving in the direction of the arrow 10. An input stage 1 through which light flux of an observation image that has been transmitted by the optical system inside the revolver holding member 106 passes, and mirrors 2a, 2b and 2c for reflecting the light flux, are provided inside the telescopic fixed member 8.

The input stage 1 contains a lens, and the observation image from the revolver holding member 106 is made into a parallel beam by this lens. The mirrors 2a, 2b and 2c can be formed as prisms or any other reflective member. Also, members such as the mirror 2a that are fixed to the telescopic fixed member 8 are covered by a rear cover 24 that is integral with the telescopic fixed member 8.

A mirror 4, lifting section 11 and cover 12 are provided inside the telescopic moving member 9. The mirror 4 reflects light flux of the observation image, that has traveled along the optical path 3, towards the binocular section 112. The mirror 4, similarly to the mirrors 2a, 2b and 2c, can be formed as a prism or any other reflective member. The lifting section 11 will be described in detail later using FIG. 6, but is an extendable mechanism for moving the binocular section 112 in the vertical direction in response to a rotation operation of the lifting handle 13.

The cover 12 covers the lifting section 11, and is formed integrally with the telescopic moving member 9. By pulling the cover 12 in the direction of the arrow 10, the lens barrel 111 is extended (refer to FIG. 3A, FIG. 3B and FIG. 5), and by pushing the cover 12 back in the lens barrel 11 is compressed (refer to FIG. 2A, FIG. 2B and FIG. 4). Accordingly it is possible to carry out a telescopic operation by operating the cover 12. Also, even in the case where the lens barrel 11 has been extended by the telescopic operation, the cover 12 always overlaps the rear cover 24 (refer to FIG. 5), shielding light from the outside.

The binocular section 112 comprises a binocular holding section 6, a binocular section 7, and ocular lenses 113. Mirrors, not shown, are provided at two locations inside the binocular holding section 6, and an optical path 5 is bent at these two locations. Also, the binocular holding section 6 adjusts the angle of the binocular section 7 with respect to the lens barrel 111 in a specified range, and angles of reflection by the mirrors at the two locations are varied in accordance with this angle adjustment to transmit light flux of an observation image from the lens barrel 111 through the optical path 5 to the binocular section 7. The binocular section 7 divides light flux of the observation image incident through the optical path 5 into two light fluxes, namely a left and a right light flux. The ocular lenses are provided in each of the two divided optical paths, and a user observes the observation image through these ocular lenses 113.

The lifting section 11 comprises a pinion gear 14, a rack 15, the lifting moving member 16 and a lifting fixed member 17, as shown in FIG. 6. The pinion gear 14 is formed on a shaft of the lifting handle 13 (refer to FIGS. 1A, 1B, 2A and 2B), and is rotatably axially supported on the lifting fixed member 17. The pinion gear 14 also meshes with the rack 15, and the rack 15 is attached to the lifting moving member 16 with screws. The lifting moving member 16 is slidably engaged with the lifting fixed member 17, and rotatably holds the binocular holding section 6.

Also, the lifting moving member 16 is fixed to an upper surface 18c of a light shielding member 18 and a plate 20. Therefore, if the observer rotates the lifting handle 13, a lifting operation of the rack 15 and lifting moving member 16 in the direction of arrow 19 is carried out. The light shielding member 18 is extended or retracted in accordance with the lifting operation. The lifting fixed member 17 is fixed to the telescopic moving member 9, and regardless of the position of the telescopic moving member 9, operation of the lifting mechanism using the lifting section 11 is possible. Also, even if there is variation in the length of the optical path 5, the optical path of the observation image light flux is constituted by the afocal optical system, and there is no effect on the observation image.

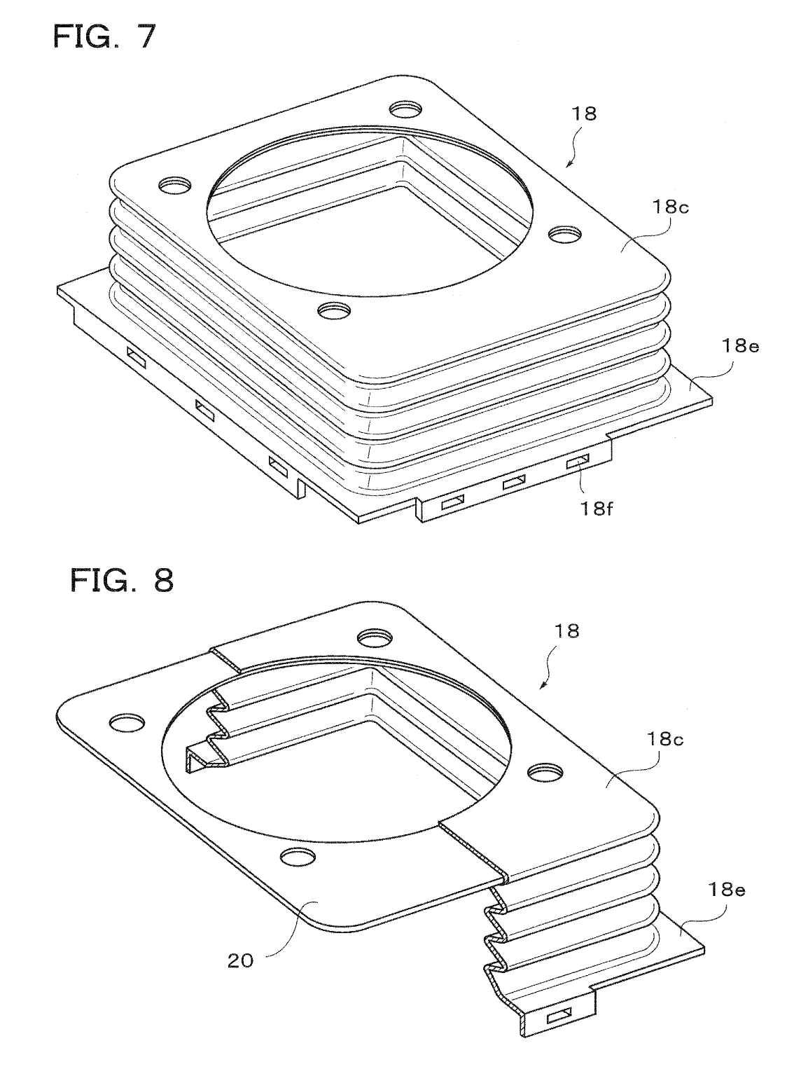

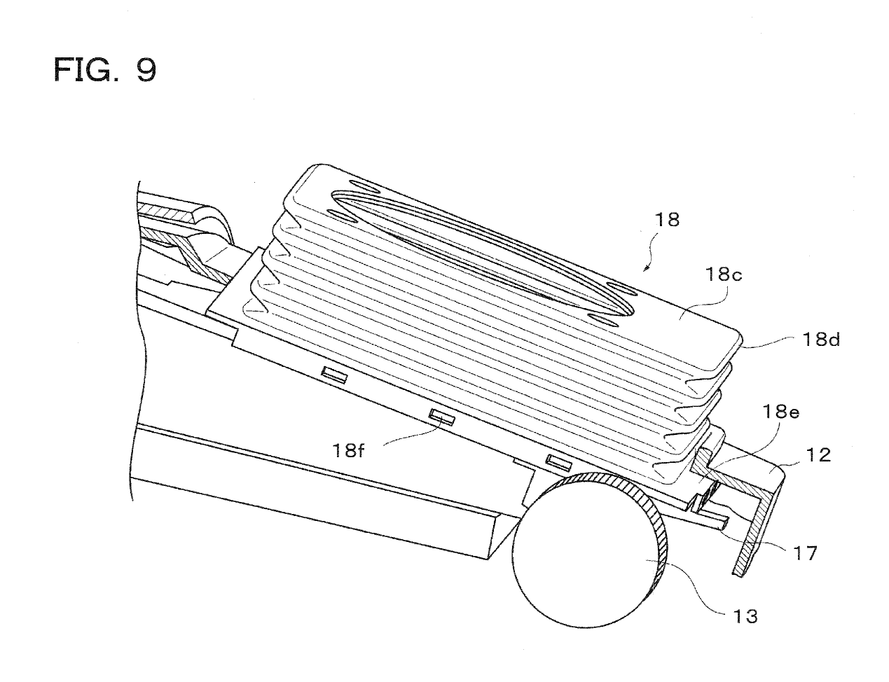

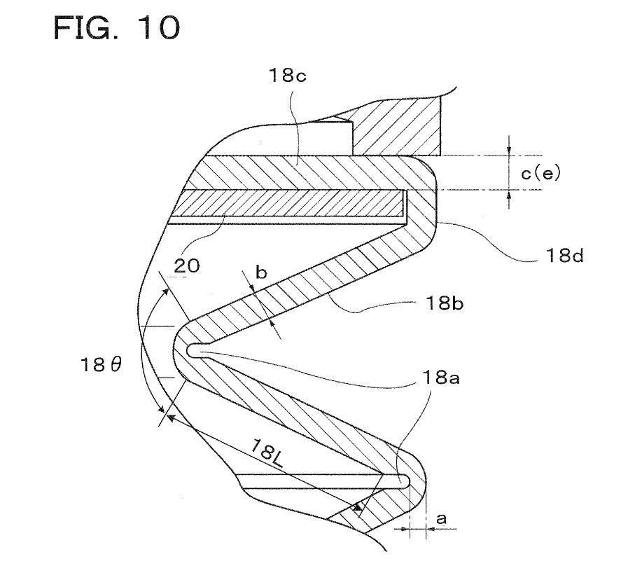

Next, the detailed structure of the light shielding member 18 will be described using FIG. 7 to FIG. 10. FIG. 7 is an external perspective view of the light shielding member 18, and FIG. 8 is a perspective view showing part of the light shielding member 18 in cross section. Also, FIG. 9 is a perspective view with part of the cover 12 shown in cross section in order to show the attachment state of the light shielding member 18. FIG. 10 is a partial enlarged cross sectional drawing of part X in FIG. 6, and shows in detail the bellows arrangement of the light shielding member 18.

The light shielding member 18 is a flexible molded component, made, for example, of rubber or elastomer, and is formed in a substantially intermediate state between the extended state and the compressed state, so that there is equal load whether in the extended state or the compressed state. A plurality of holes 18f are provided in a lower surface 18e of the light shielding member 18, and as shown in FIG. 9 projections of the telescopic moving member 9 and the lifting fixed member 17 are engaged in these holes 18f and fixed. As a result it is possible to easily attach and detach the light shielding member 18. Also, since the entire periphery of the light shielding member 18 is uniformly fixed, the lower surface 18e is pressed against the telescopic moving member 9 and the lifting fixed member 17 by the cover 12.

An outer section 18d of the upper surface 18c of the light shielding member 18 is formed in a substantially square or substantially rectangular shape, and outer sections of apexes of intermediary mountain folds of the bellows section are also formed in substantially the same shape. The upper surface 18c of the light shielding member 18 contains a plate 20 having a shape that generally fits into the outer section 18d (refer to FIG. 8). The material of the plate 20 is preferably a hard material, such as metal or resin, etc. The plate 20 is fitted at the position shown in the drawing, while pulling and stretching the bellows section from the lower surface 18e, after formation of the light shielding member 18.

As shown in FIG. 6, the plate 20 and the upper surface 18c of the light shielding member 18 are fixed to the lifting moving member 16, and the lower surface 18e of the light shielding member 18 is fixed to the lifting fixed member 17, and so the bellows shape of the light shielding member 18 extends or retracts in accordance with the lifting operation. The shapes of the outer section 18d of the upper surface 18c and the plate 20 can also be substantially circular or elliptical.

As shown in FIG. 10, thinned sections are provided at the valley side of bending sections 18a of the light shielding member 18, that are thinner than wall sections 18b. The bending sections 18a are portions that are deformed at the time of extension or compression of the light shielding member 18, and in FIG. 10 the extent of deformation is shown by the range 18θ. Also, the wall sections 18b are sites that are not deformed even if there is extension and compression, and in FIG. 10 are shown by a range of 18L. Boundaries between the bending sections 18a and the wall sections 18b are more or less in the vicinity of points of contact between straight lines running parallel to the wall sections 18b and curved lines running along the curved surfaces of the bending sections 18a.

Here, if the thickness of the thinned sections of the bending sections 18a is made a, the thickness of the wall sections 18b is made b, and the thickness of the upper surface 18c (or the lower surface 18e) is made c (e), then these thicknesses preferably have the following relationship.

(⅓)b≦a≦(⅔)b (1)

( 3/2)b≦c(e)≦3b (2)

Accordingly, thickness of the bending sections 18a is desirably between ⅓ and ⅔ that of the wall sections 18b, and in particular, the optimum thickness is ½ the thickness of the wall sections 18b. Also, the thickness of the upper surface 18c and the lower surface 18e is thicker than that of the wall sections 18b, desirably from 1.5 to three times the thickness. The reason the thickness of the upper surface 18c and the lower surface 18e is thicker than that of the wall sections 18b is to reliably hold the light shielding member 18 at the upper surface 18c and lower surface 18e when extending and compressing the bellows section.

With this embodiment, the upper surface 18c and the lower surface 18e are of the same thickness, but they can also be of different thicknesses as long as they are thicker than the wall sections 18b. Since the upper surface 18c is reinforced by the plate 20, there is no problem if the upper surface 18c is thinner than the lower surface 18e.

Operation of this embodiment will next be described. The telescopic operation will be described first. The telescopic operation is an operation to either extend or compress the lens barrel 111 in the telescopic direction (horizontal direction), as described previously. If the user grasps part of the cover 12 and pulls in the direction of the arrow 10 (refer to FIG. 2A, FIG. 2B and FIG. 4), the telescopic moving member 9 moves in the direction of the arrow 10 relative to the telescopic fixed member 8, the binocular section 112 that is capable of movement together with the telescopic moving member 9 also moves, and the lens barrel 111 is extended (refer to FIG. 5). In this case, the part that extends or shortens the optical path 3 inside the lens barrel 111 is constituted by an afocal optical system, which means that there is no effect on the observation image even if there is variation in the optical path length. If the user grasps part of the cover 12 and pushes in the opposite direction, the telescopic moving member 9 moves in the opposite direction, and the lens barrel 111 is compressed (refer to FIG. 2A, FIG. 2B and FIG. 4).

Next, the lifting operation will be described. The lifting operation is an extension and compression operation to move the movable member inside the lens barrel in the vertical direction, as described previously, and the binocular section 112 is moved up or down in accordance with this extension and compression operation. If the user rotates the lifting handle 13, the pinion gear 14 rotates, and the rack 15 that meshes with the pinion gear 14 is moved upwards or downwards. If the rack 15 moves either up or down, the lifting moving member 16 that is integrally formed with the rack 15 also moves up or down, and the binocular section 112 that is held by the lifting moving member 16 also moves up or down. Specifically, the lifting operation to move the binocular section 112 up and down is realized by a rotation operation of the lifting handle 13.

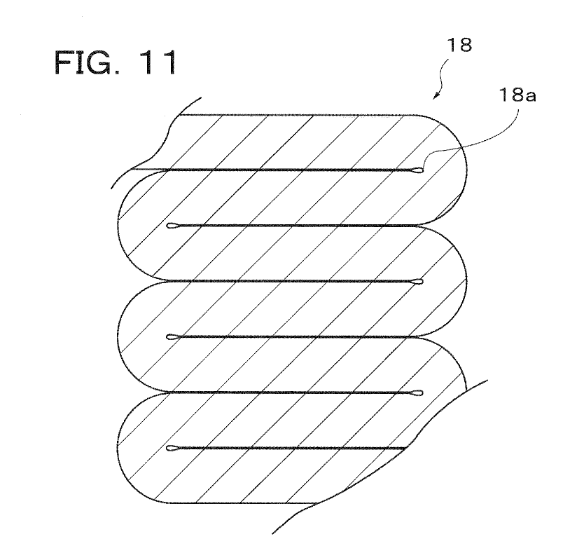

At the time of the lifting operation, if the upper surface 18c is pulled up, the wall sections 18b are not deformed and the bending sections 18a are reliably bent and stretched because the thickness of the valley side of the bending sections 18a is thinner than the wall sections 18b, as shown in FIG. 10. Also, in the case where the upper surface 18c is pulled down, fellow wall sections 18b of the light shielding member 18 that are facing each other stick to each other as they are squashed down, and as shown in FIG. 11, deformation such as the bending sections 18a being abnormally projected does not occur.

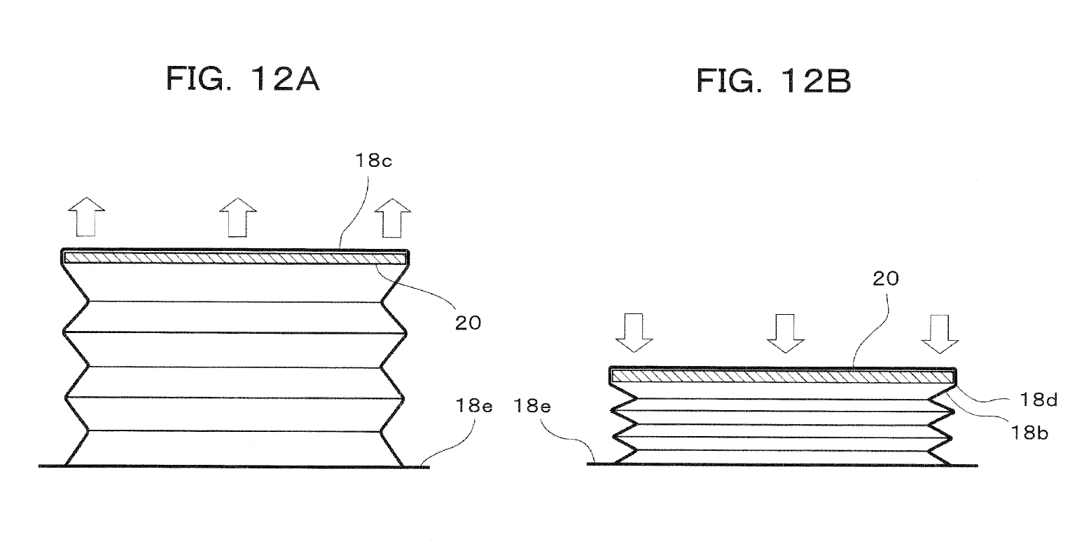

Also, when the light shielding member 18 is pulled up by the lifting operation, there is an operation such that the plate 20 pulls up the entire upper surface 18c, as shown in FIG. 12A. When the light shielding member 18 is pushed down, there is an operation such that the plate 20 pushes down all of the wall sections 18b, as shown in FIG. 12B. As a result, the wall sections 18b are uniformly moved up and down, no matter what side they are viewed from. The upper surface 18c and the lower surface 18e are also thicker than the wall sections 18b, which means that they do not perform an extending or contracting action.

As has been described above, the light shielding member of this embodiment has bending sections 18a formed thinner than wall sections 18b. It is therefore possible to provide a low-priced bellows system while keeping the bellows section in a good configuration with the bending sections 18a stretched out and no deformation of the wall sections 18b when extending or compressing upwards or downwards. In particular, there is no occurrence of abnormal deformation of the bending sections 18a, even when wall sections 18b stick together when being squashed down. With a conventional light shielding member as shown in FIG. 16, since thickness of the bending sections is substantially the same as the thickness of the wall sections, or thicker, in the event that the wall sections stick together when squashed down the bending sections are abnormally projected With the embodiment of the present invention described above, this type of deformation does not arise.

Also with this embodiment, the plate 20 having a shape that generally fits the upper surface 18c is included. As a result, the upper surface 18c does not deform when being extended or compressed up or down, and instead the bellows section deforms. It is also possible to move the light shielding member 18 uniformly up and down no matter what direction it is viewed from, and it is possible to keep the ridge line of the bellows, which is formed of a plurality of steps, neat.

### Modified Example 1

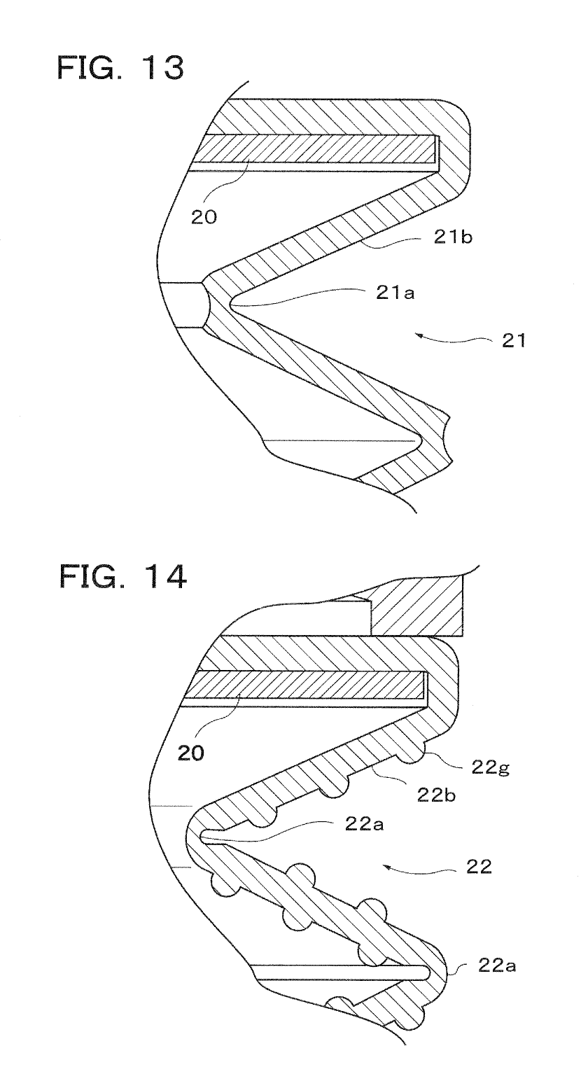

The light shielding member 21 shown in FIG. 13 is a modified example 1 of the light shielding member 18. In the embodiment of the present invention described above, the bending sections 18a were provided at a valley side of a bending section, but in this modified example the peak side of the bending section is made a thinned section to provide bending sections 21a. The thickness of these bending sections 21a is thinner than that of the wall sections 21b. The thickness of the bending sections 21a, similarly to the case of the embodiment described above, is about ⅓ to ⅔ the thickness of the wall sections 21b, and is optimally ½ the thickness of the wall sections 21b. The operation and effects of this modified example are similar to those of the embodiment described above, and so a detailed description thereof is omitted.

### Modified Example 2

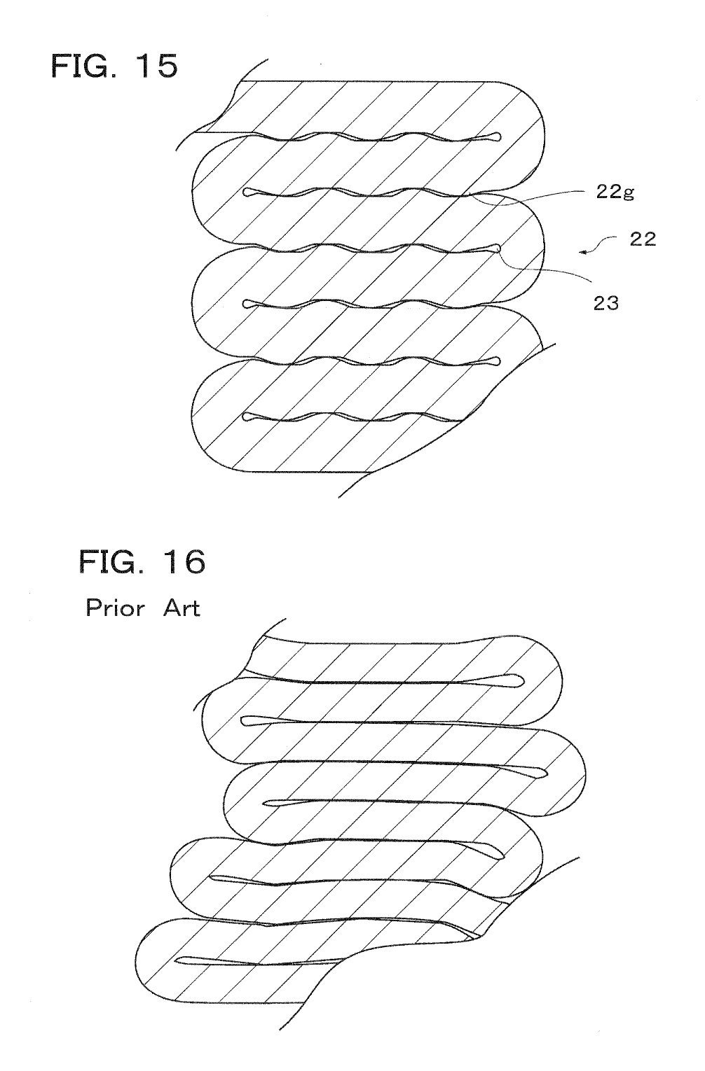

As a second modified example of the light shielding member 18, the light shielding member 22 having convex portions is shown in FIG. 14 and FIG. 15. In the embodiment of the present invention described above, surfaces of the wall sections 18b that face each other were only flat surfaces. With this modified example, a plurality of substantially hemispherical ribs 22g are provided as convex portions on flat surfaces of the wall sections 22b that face each other.

With this modified example, the ribs 22g are about ½ the thickness of the wall sections 22b, but can also be appropriately changed so as to become optimum taking into account the material and the like of the wall sections 22b. Also, the ribs 22g are positionally offset so that associated ribs 22b that face each other do not touch when the bellows section has been folded up to the state where the wall sections 22b contact. With this modified example, the convex portions are substantially hemispherical, but this is not limiting, and they can be any shape, such as cylindrical or conical, as long as they project from the flat surface.

With this modified example also, since the thickness of the bent sections 22a is thinner than the thickness of the wall sections 22b, then similarly to the embodiment of the present invention described above, when extending or compressing vertically, the bending sections 22a are bent and stretched, and there is no deformation of the wall sections 22b.

Also, in addition to the effect of the embodiment of the present invention described above, with this modified example, when the bellows section is folded down the ribs 22g contact wall sections 22b that are facing them, creating a lot of gaps 23 (FIG. 15), and the surface area of associated walls that stick to each other is reduced. As a result, when a lifting operation is carried out after the bellows configuration has been folded down and kept in the adhered state for a prolonged period of time, it is possible to prevent associated wall sections sticking together, ensuring a smooth operation with no degradation to the appearance of the finished product, even if operation is commenced after a prolonged period of inactivity. This effect is particularly pronounced in a case where the light shielding member 22 is constructed of a flexible material such as rubber,

As has been described above, with the embodiment and modified examples, bending sections 18a, 21a, 22a of a light shielding member are made thinner than wall sections 18b, 21b, 22b. As a result, it is possible to prevent abnormal deformation of a bellows type light shielding member 18, 21, 22 when an extending and compressing mechanism is moved, and it is possible to keep the external appearance in an attractive state.

A description has been given of an example where the present invention is applied to a bellows type light shielding member at a section where a lifting operation of a lens barrel 111 is carried out. However, this is not limiting and it is possible to apply the present invention as long as it is between a moving member and a fixed member, such as a stage and an objective lens, as is disclosed in patent publication 1 for example, or between members that have a varying distance between each other.

Also, a description has been given with the shape of the light shielding member 18 being substantially square or substantially rectangular, but the invention is not limited to this shape and can be any shape as long as it is a shape that does not hinder extension or compression, such as a circle, ellipse or polygon.

The present invention is not limited to the above described embodiments, and structural elements may be modified in actual implementation within the scope of the gist of the embodiments. It is also possible form various inventions by suitably combining the plurality of structural elements disclosed in the above described embodiments. For example, it is possible to omit some of the structural elements shown in the embodiments. It is also possible to suitably combine structural elements from different embodiments.

What is claimed is:

1. A microscope, comprising:
a fixed section;
a moving section capable of moving relative to the fixed section; and
a bellows type light shielding member that extends and contracts, provided between the fixed section and the moving section,
wherein bending sections of the light shielding member are thinner than wall sections of the light shielding member.

2. The microscope of claim 1, wherein an outer part of an upper surface of the light shielding member is formed in a substantially square or substantially rectangular shape, and further comprising a plate that is fittable to the upper surface.

3. The microscope of claim 1, wherein the light shielding member has an upper surface and a lower surface that are thicker than the wall sections.

4. The microscope of claim 1, wherein the light shielding member has convex portions on opposing surfaces.

5. A microscope lens barrel provided with an expandable mechanism, comprising:
a bellows type light shielding member that is extended or contracted by the expandable mechanism,
wherein bending portions of the light shielding member are thinner than wall sections of the light shielding member,
wherein an outer part of an upper surface of the light shielding member is formed in a substantially square or substantially rectangular shape,
wherein a plate is fittable to the upper surface of the light shielding member, and
wherein the upper surface of the light shielding member and a lower surface of the light shielding member are thicker than the wall sections of the light shielding member.
